(19) United States
(12) Patent Application Publication
(10) Pub. No.: US 2011/0109264 A1
(43) Pub. Date: May 12, 2011

(54) APPARATUS AND METHOD FOR PROVIDING CHARGE IN BATTERY CHARGING SYSTEM

(75) Inventor: Dae-Eun CHOI, (US)

(73) Assignee: Samsung Electronics Co., Ltd., Suwon-si (KR)

(21) Appl. No.: 12/942,536

(22) Filed: Nov. 9, 2010

(30) Foreign Application Priority Data
Nov. 9, 2009 (KR) 10-2009-0107367

(51) Int. Cl. H02J 7/00

(52) U.S. Cl. 320/108

(57) ABSTRACT

Disclosed is a charging apparatus and method of a battery charging system, including a power supply unit supplying power for charging a battery of a terminal if the position of a charging coil of the battery charging system matches the position of a charging coil of the terminal, a sensing unit obtaining the sensing information for determining the position of the terminal, a position detecting unit determining the position of the terminal on the basis of the sensing information obtained by the sensing unit, a charging coil coupled inductively with the charging coil of the terminal to generate power for charging the battery of the terminal, a coil moving unit moving the charging coil to the position of the terminal, and a control unit controlling a battery charging operation by the charging coil of the terminal and the charging coil moved by the coil moving unit.

### PRIORITY

This application claims priority under 35 U.S.C. §119 to an application filed in the Korean Intellectual Property Office on Nov. 9, 2009 and assigned Serial No. 10-2009-0107367, the contents of which are incorporated herein by reference.

### BACKGROUND OF THE INVENTION

1. Field of the Invention

The present invention relates generally to a battery charging system for charging a battery of a portable terminal and, in particular, to an apparatus and method for providing a noncontact battery charging system, which uses a mobile charging coil to match the position of a charging coil for a portable terminal battery with the position of a charging coil of a charging device for non-contact charging of the battery of the portable terminal.

2. Description of the Related Art

Rechargeable batteries of portable terminals such as mobile terminals and personal information devices (e.g. PDAs, notebook computers, and multimedia players, etc) allow for operation anywhere, at any time.

To charge a battery of a portable terminal, a commercial power source is used to supply electrical energy to the battery, via a charging device, typically operates by physically plugging into, i.e. contacting, a contact terminal of the charging device.

What has recently been proposed is a noncontact battery charger to charge a battery without having to connect the battery with the charging device.

The noncontact battery charger utilizes an inductive coupling between a charging coil of a portable terminal, i.e., a charging coil of the battery, and a charging coil of a charging device. However, the ability to adequately charge, i.e. ‘chargeability’, depends on the relative position between the charging coils.

For conventional noncontact battery chargers, the battery can be charged only when the position of the charging coil of the portable terminal matches the position of the charging coil of the charging device. If the positions of the charging coils do not match, the battery cannot be charged by the noncontact battery charging method. Therefore, the user is inconvenienced by having to manually match the positions of the charging coils when charging the battery.

A charging device having a groove formed thereon for locating a portable terminal and using a strong, i.e. oversized, magnet for the charging coil to overcome misalignment of the portable terminal with to the position of the charging coil have been proposed.

However, such conventional devices for correcting the position of the portable terminal by the strong magnet increase the production cost of the portable terminal, particularly when an oversized magnet is used.

Also proposed is to equip the charging device with a plurality of charging coils to increase the probability of matching the position of the charging coil of the charging device and the position of the charging coil of the battery. However, this proposal increases power consumption due to the need to supply power to the plurality of charging coils.

What is therefore required is an apparatus and method for solving the above problems in portable terminals.

### SUMMARY OF THE INVENTION

The present invention is designed to substantially solve at least the above problems and/or disadvantages and to provide at least the advantages described below. Accordingly, the present invention provides an apparatus and method for improving a noncontact battery charging performance in a battery charging system.

An aspect of the present invention provides an apparatus and method for moving a charging coil of a charging device in a battery charging system to match the position of the charging coil of the charging device with the position of a charging coil of a battery.

Another aspect of the present invention provides an apparatus and method for supplying power only to a charging coil having the same position as a charging coil of a battery in a battery charging system having a plurality of charging coils.

In accordance with an aspect of the present invention, a charging apparatus of a battery charging system is provided. The apparatus includes a power supply unit supplying power for charging a battery of a terminal if the position of a charging coil of the battery charging system matches with the position of a charging coil of the terminal; a sensing unit for obtaining the sensing information for determining the position of the terminal; a position detecting unit for determining the position of the terminal on the basis of the sensing information obtained by the sensing unit; a charging coil coupled inductively with the charging coil of the terminal to generate power for charging the battery of the terminal; a coil moving unit for moving the charging coil of the battery charging system to the position of the terminal; and a control unit for controlling a battery charging operation by the charging coil of the terminal and the charging coil moved by the coil moving unit.

In accordance with another aspect of the present invention, a charging method of a battery charging system is provided. The method includes supplying power for charging a battery of a terminal if the position of a charging coil of the battery charging system matches with the position of a charging coil of the terminal; obtaining the sensing information for determining the position of the terminal; determining the position of the terminal on the basis of the obtained sensing information; inductively coupling the charging coil of the terminal and the charging coil of the battery charging system to generate power for charging the battery of the terminal; moving the charging coil of the battery charging system to the position of the terminal; and charging the battery of the terminal by the charging coil of the terminal and the moved charging coil of the battery charging system.

### BRIEF DESCRIPTION OF THE DRAWINGS

The above and other aspects, features and advantages of certain embodiments the present invention will become more apparent from the following detailed description when taken in conjunction with the accompanying drawings in which:

FIG. 1 is a block diagram of a battery charging system providing a noncontact charge according to the present invention;

FIG. 2 is a flow diagram illustrating a method for charging a battery of a portable terminal in a battery charging system according to the present invention;

FIG. 3A is a diagram illustrating a battery charging system having a mobile charging coil according to an embodiment of the present invention;

FIG. 3B is a diagram illustrating a battery charging system having mobile charging coils according to another embodiment of the present invention;

FIG. 3C is a diagram illustrating a battery charging system according to another embodiment of the present invention;

FIG. 4A is a diagram illustrating a method for operating a battery charging system having a mobile charging coil according to an embodiment of the present invention;

FIG. 4B is a diagram illustrating a method for operating a battery charging system having mobile charging coils according to another embodiment of the present invention; and

FIG. 4C is a diagram illustrating a method for operating a battery charging system according to another embodiment of the present invention.

### DETAILED DESCRIPTION OF EMBODIMENTS OF THE INVENTION

The following description with reference to the accompanying drawings is provided to assist in a comprehensive understanding of certain embodiments of the present invention, as defined by the claims and their equivalents. It includes various specific details to assist in that understanding although these are to be regarded as merely exemplary. Accordingly, a person having ordinary skill in the art will recognize that various changes and modifications of the embodiments described herein can be made without departing from the scope and spirit of the present invention. Also, descriptions of well-known functions and constructions are omitted for clarity and conciseness.

Further, the terms and words used in the following description and claims are not limited to their dictionary meanings, but are merely used by the inventor to enable a clear and consistent understanding of the present invention.

The present invention provides an apparatus and method for moving a charging coil of a battery charging system to match the position of the charging coil of the battery charging system with the position of a charging coil of a battery to improve the noncontact battery charging performance of the noncontact battery charging system.

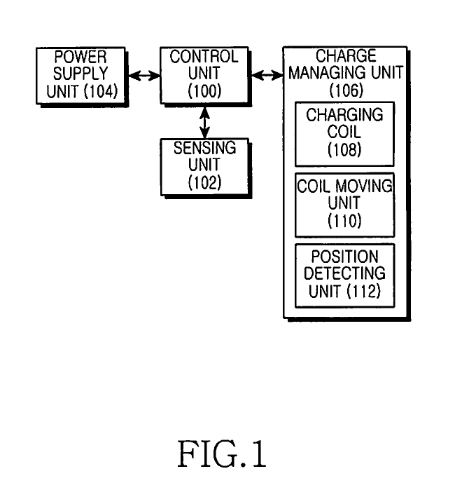

FIG. 1 is a block diagram of a battery charging system providing a noncontact charge according to the present invention.

Referring to FIG. 1, the battery charging system includes a control unit 100, a sensing unit 102, a power supply unit 104, and a charge managing unit 106. The charge managing unit 106 includes a charging coil 108, a coil moving unit 110, and a position detecting unit 112. The battery charging system may include additional units. Similarly, as an alternative construction, the functionality of two or more of the above units may be integrated into a single component.

The control unit 100 controls an overall operation of the battery charging system. For example, the control unit 100 controls a process for charging a battery of a portable terminal connected to the battery charging system, and enables a noncontact battery charging operation of charging the battery without contacting a charge terminal of the portable terminal.

Additionally, the control unit 100 improves a noncontact battery charging performance by matching the position of a charging coil of the battery and the position of a charging coil of the battery charging system when performing the noncontact battery charging operation according to the present invention.

That is, when the portable terminal is disposed in the battery charging system, if the position of the charging coil of the battery charging system does not match the position of the charging coil of the portable terminal, the control unit 100 performs a control operation for moving the position of the charging coil of the battery charging system to the position of the charging coil of the portable terminal to charge the battery of the portable terminal.

According to an embodiment of the present invention, in order to perform the above operation, the control unit 100 controls the charge managing unit 106 to detect the position of the portable terminal and to move the position of the charging coil of the battery charging system to the detected position.

According to another embodiment of the present invention, the battery charging system is provided with a plurality of charging coils, and the control unit 100 controls the charge managing unit 106 to operate only the charging coil of the battery charging system located at the position of the portable terminal.

Under the control of the control unit 100, the charge managing unit 106 matches the position of the charging coil of the battery charging system with the position of the charging coil of the portable terminal.

Also, under the control of the control unit 100, the charge managing unit 106 detects the position of the portable terminal and operates only the charging coil of the battery charging system present at the position of the portable terminal, to reduce the power consumption.

The charging coil 108 of the charge managing unit 106 is provided to charge the battery of the portable terminal. The charging coil 108 supplies charge power to the battery when in the same position as the charging coil of the portable terminal.

Also, the charging coil 108 is inductively coupled with the charging coil of the battery of the portable terminal to charge the battery. According to an exemplary embodiment of the present invention, the charging coil 108 is coupled with a driving motor to move to the charging coil to a position corresponding to the portable terminal by vertical/horizontal/diagonal movements.

According to another embodiment of the present invention, the charging coil 108 includes a plurality of fixed charging coils instead of a mobile charging coil, and only the charging coil having the same position as the portable terminal is operated to supply power to the battery.

The coil moving unit 110 moves the charging coil 108 to the position of the portable terminal, that is, the position of the charging coil of the portable terminal. The coil moving unit 110 moves the mobile charging coil 108 near to the portable terminal and then decreases the moving interval to provide the optimal position of the charging coil 108.

The position detecting unit 112 determines the position of the portable terminal based on the sensing information of sensors, e.g., illumination, proximity and temperature sensors, that can sense the presence of the portable terminal.

The sensing unit 102 includes sensors for sensing the position of the portable terminal. The sensing unit 102 provides the sensing information of the sensors to the charge managing unit 106 to determine the position of the portable terminal.

The power supply unit 104 supplies power for an operation of the battery charging system that charges the battery of the portable terminal. That is, the power supply unit 104 supplies power for operating the battery charging system and charging the battery of the portable terminal.

Those skilled in the art will understand that the functionality associated with the control unit 100 may be centralized or distributed, whether locally or remotely. For example, the control unit 100 may also perform the function of the charge managing unit 106.

A description has been given of an apparatus for moving a charging coil of a battery charging system to match the position of the charging coil of the battery charging system with the position of a charging coil of a battery to improve the noncontact battery charging performance of the battery charging system, according to an embodiment of the present invention. Hereinafter, a description will be given of a method for moving a charging coil of a battery charging system to match the position of the charging coil of the battery charging system with the position of a charging coil of a battery to improve the noncontact battery charging performance of the battery charging system, according to an embodiment of the present invention.

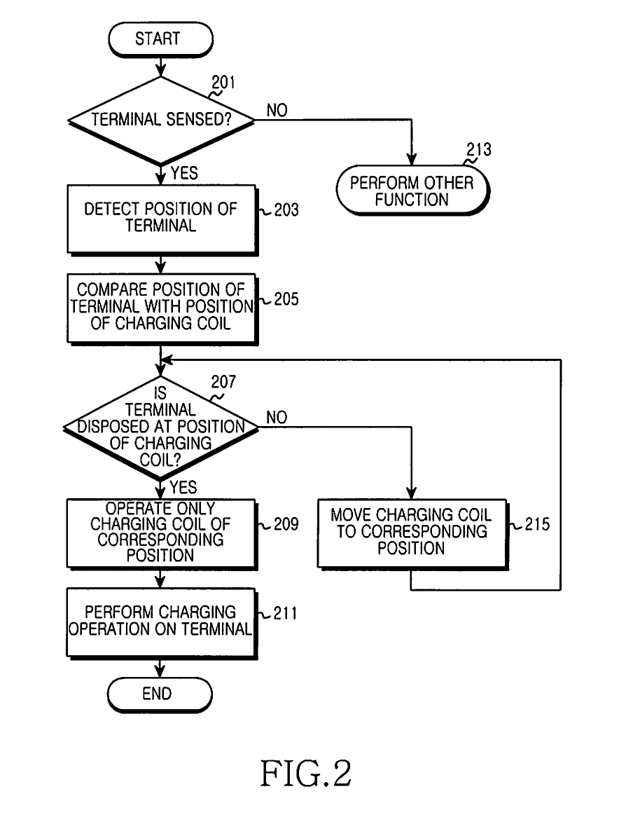

FIG. 2 is a flow diagram illustrating a method for charging a battery of a portable terminal in a battery charging system according to the present invention.

Referring to FIG. 2, in step 201, the battery charging system determines whether a portable terminal is sensed.

Herein, the battery charging system includes sensors capable of sensing the presence of the portable terminal, to obtain the sensing information of the sensors to sense the portable terminal.

If a portable terminal is not sensed in step 201, the battery charging system proceeds to step 213. In step 213, the battery charging system performs another function, such as proceeding to a standby mode.

On the other hand, if a portable terminal is sensed in step 201, the battery charging system proceeds to step 203. In step 203, the battery charging system detects the position of the portable terminal. In step 205, the battery charging system compares the position of the portable terminal with the position of the charging coil of the battery charging system.

That is, the battery charging system determines the chargeability of the battery by determining whether the charging coil is present at the position of the portable terminal.

In step 207, the battery charging system detects the comparison result of step 205.

If it is determined in step 207 that the charging coil is present at the position of the portable terminal, i.e., the battery is chargeable, the battery charging system proceeds to step 209. In step 209, the battery charging system operates only the charging coil at the corresponding position, that is the position corresponding to the position of the portable terminal.

In step 211, the battery charging system charges the battery of the portable terminal using only the operating charging coil.

That is, according to an embodiment of the present invention, the battery charging system includes a plurality of charging coils. The battery charging system does not supply power to the charging coils when the portable terminal does not contact the battery charging system. The battery charging system supplies power to the charging coil when the portable terminal contacts the battery charging system. Herein, the battery charging system supplies power only to the charging coil located at the contact position of the portable terminal, thus reducing the power consumption.

On the other hand, if it is determined in step 207 that the charging coil is not present at the position of the portable terminal, i.e. the battery is not chargeable, the battery charging system proceeds to step 215. In step 215, the battery charging system moves its charging coil to the position of the portable terminal. Herein, the charging coil of the battery charging system is coupled with a driving motor to move in various directions, i.e., vertical/horizontal/diagonal directions. The battery charging system detects the interval between the portable terminal and its charging coil and moves its charging coil to the position of the charging coil of the battery of the portable terminal, thus improving the battery charging performance. For example, if a large gap between the portable terminal and the charging coil of the battery charging system is out of the threshold value, the battery charging system rapidly moves its charging coil toward the portable terminal at large intervals and then if the gap is in the threshold value, the battery charging system accurately moves its charging coil to the position of the portable terminal at small intervals.

Thereafter, the battery charging system returns to step 207, and performs the above described battery charging operation by moving its charging coil adjacent to the portable terminal.

As described above, the battery charging system may basically include one mobile charging coil to move a charging coil, and may include as many charging coils as the number of portable terminals to be simultaneously charged. Thereafter, the battery charging system ends the algorithm of FIG. 2.

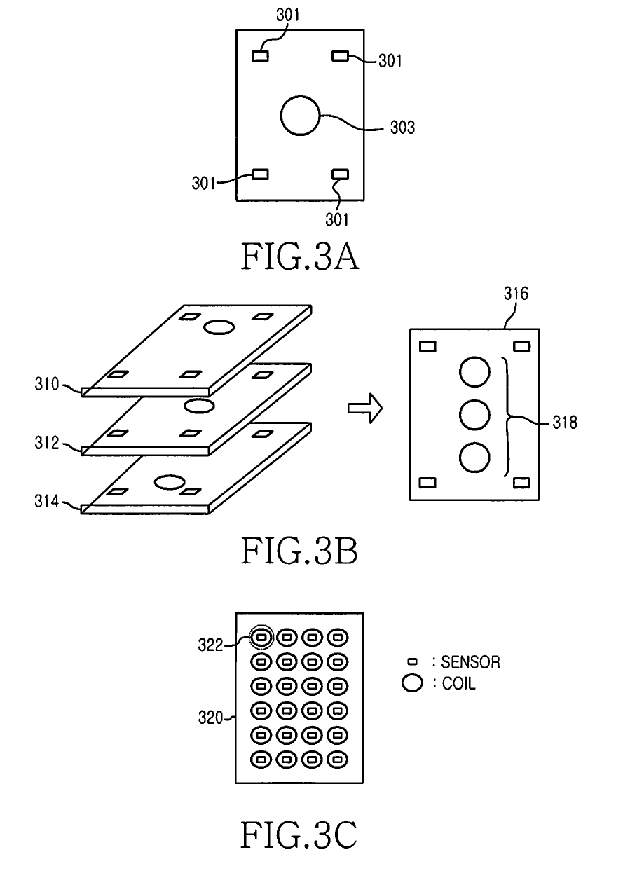

FIGS. 3A-3C illustrate a battery charging system providing a noncontact charger according to the present invention.

Referring to FIG. 3A, the battery charging system 300 includes a plurality of sensors 301 for determining the position of a portable terminal and contact by the portable terminal; and a mobile charging coil 303 coupled inductively with a charging coil of a battery of the portable terminal.

The battery charging system determines the position of the portable terminal on the basis of the sensing information of the sensors, determines the position of the portable terminal as the position of a battery charging coil, and moves the mobile charging coil 303 toward the portable terminal.

Accordingly, the position of the mobile charging coil 303 matches with the position of the charging coil of the portable terminal, i.e., the charging coil of the battery of the portable terminal, thus enabling a battery charging operation.

Referring to FIG. 3B, the battery charging system 316 includes a plurality of sensors for determining the position of a portable terminal and contact by the portable terminal; and a plurality of charging sheets each including a mobile charging coil, thus making it possible to simultaneously charge the batteries of as many portable terminals as there are charging sheets.

For example, if the battery charging system 316 includes three charging sheets 310, 312 and 314, the battery charging system 316 includes three mobile charging coils 318, thus making it possible to simultaneously charge the batteries of up to three portable terminals.

In FIG. 3B, three charging sheets 310, 312 and 314 are provided in the battery charging system 316. The mobile charging coils 318 are provided in the same number as the charging sheets, and the positions of the charging coils may vary.

Referring to FIG. 3C, the battery charging system 320 includes a plurality of charging coils that respectively include a plurality of sensors 322 for determining the contact of portable terminals. Herein, the charging coil is fixed, unlike the embodiments described above, and may operate separately by receiving power separately.

That is, the battery charging system does not supply power to all of the charging coils in a standby state, and supplies power only to the charging coil at positions corresponding to the positions of the portable terminal.

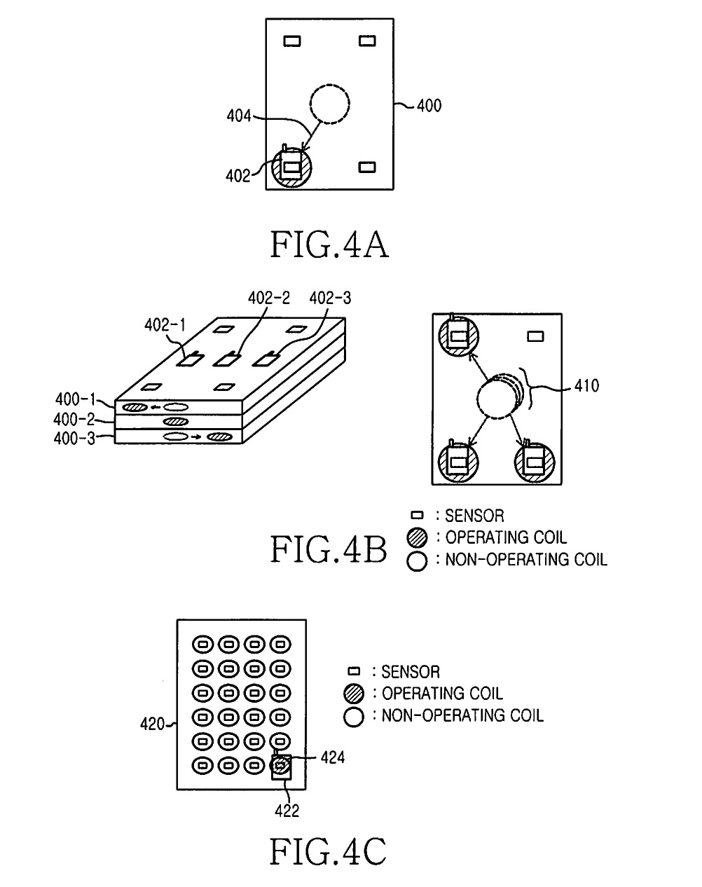

FIGS. 4A-4C illustrate a method for operating a battery charging system according to the present invention.

Referring to FIG. 4A, the battery charging system 400 includes a mobile charging coil movable by a driving motor; and a plurality of sensors for determining the position of a portable terminal 402.

Accordingly, the portable terminal 402 is located in the battery charging system 400, the battery charging system 400 uses the sensing information of the sensors to determine the position of the portable terminal 402.

If the mobile charging coil is located at the position of the portable terminal 402, the battery charging system 400 performs a battery charging operation using the mobile charging coil and a charging coil of the portable terminal.

However, if the mobile charging coil is not located at the position of the portable terminal 402, the battery charging system 400 cannot perform a battery charging operation.

In order to solve the above problem, the battery charging system 400 according to the present invention moves along path 404 the mobile charging coil to the position of the portable terminal 402 to match the position of the mobile charging coil with the position of the charging coil of the portable terminal to charge the battery.

Referring to FIG. 4B, the battery charging system includes a plurality of sensors for determining the position of a portable terminal and the contact of the portable terminal; and a plurality of charging sheets 400-1, 400-2 and 400-3 each including a mobile charging coil, thus making it possible to simultaneously charge the batteries of as many portable terminals 402-1, 402-2 and 402-3 as corresponds to the number of the charging sheets.

For example, if the battery charging system includes three charging sheets, the battery charging system includes three mobile charging coils, thus making it possible to simultaneously charge the batteries of up to three portable terminals.

If the first portable terminal 402-1 is located in the battery charging system including three charging sheets, the charging coil of the charging sheet 400-1 moves to the position of the first portable terminal 402-1.

Thereafter, if the second portable terminal 402-2 is located in the battery charging system, the charging coil of the charging sheet 400-2 moves to the position of the second portable terminal 402-2. Likewise, if the third portable terminal 402-3 is located in the battery charging system, the charging coil of the charging sheet 400-3 moves to the position of the third portable terminal 402-3.

Accordingly, the battery charging system can support a plurality of portable terminals, thus making it possible to simultaneously charge a plurality of batteries.

That is, the charging coils of the battery charging system move respectively to the portable terminals (410) to perform a battery charging operation.

Referring to FIG. 4C, the battery charging system 420 includes a plurality of charging coils; and a plurality of sensors for determining the contact of portable terminals. Herein, the battery charging system 420 may include sensors corresponding respectively to charging coils, or may include sensors corresponding to coils of a predetermined region.

In a standby state, the battery charging system 420 does not supply power to the charging coils, and uses the sensing information of the sensors to detect the position of the portable terminal 422.

Thereafter, the battery charging system 420 supplies power only to the charging coil 424 corresponding to the position of the portable terminal 422 to match the position of the charging coil 424 with the position of the charging coil of the portable terminal.

Accordingly, the battery charging system 420 supplies power only to the charging coil present at the position of the portable terminal 422 to charge the battery of the portable terminal 422. This makes it possible to solve the problem of power consumption caused by the power supply to a plurality of charging coils.

As described above, the present invention moves the charging coil of the battery charging system to match the position of the charging coil of the battery charging system with the position of the charging coil of the battery, thus improving the noncontact battery charging performance. Also, the user need not manually set the battery charging position.

While the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A charging apparatus of a battery charging system, the apparatus comprising:
a power supply unit supplying power for charging a battery of a terminal if a position of a charging coil of the battery charging system matches a position of a charging coil of the terminal;
a sensing unit for determining a position of the terminal;
a position detecting unit for determining the position of the terminal based on information obtained by the sensing unit;
the charging coil of the battery charging system inductively coupled with the charging coil of the terminal to generate power for charging the battery of the terminal;
a coil moving unit for moving the charging coil of the battery charging system to the position of the terminal; and
a control unit for controlling the charging coil of the terminal and controlling movement of the charging coil by the coil moving unit.

2. The charging apparatus of claim 1, wherein the charging coil of the battery charging system comprises a plurality of charging coils capable of separate power supply.

3. The charging apparatus of claim 2, wherein the control unit performs a control operation of not supplying power to the charging coils in a standby state and supplying power only to a charging coil present at the position of the terminal.

4. The charging apparatus of claim 2, wherein the charging coil comprises a sensing unit at each of the plurality of sensing coils or includes a sensing unit at each of the plurality of sensing coils corresponding to a predetermined region.

5. The charging apparatus of claim 1, wherein the charging coil comprises a plurality of charging coils that to respective charging coils of a plurality of terminals utilizing the battery charging system.

6. The charging apparatus of claim 5, wherein one charging coil is included in each of a plurality of charging sheets, to simultaneously charge the plurality of terminals.

7. The charging apparatus of claim 1, wherein the charging coil is movable by a driving motor in one of up, down, left and right directions.

8. The charging apparatus of claim 1, wherein the sensing unit comprises at least one of an illumination sensor, a proximity sensor and a pressure sensor.

9. The charging apparatus of claim 1, wherein if a large gap exists between the terminal and the charging coil, the coil moving unit rapidly moves the charging coil of the battery charging system near to the position of the terminal and then slowly moves the charging coil to the position of the terminal.

10. The charging apparatus of claim 1, wherein the battery charging system is applied to portable terminals including mobile terminals.

11. A charging method of a battery charging system, the method comprising:
supplying power for charging a battery of a terminal if a position of a charging coil of the battery charging system matches a position of a charging coil of the terminal;
obtaining the sensing information for determining a position of the terminal;
determining the position of the terminal based on the obtained sensing information;
inductively coupling the charging coil of the terminal and the charging coil of the battery charging system to generate power for charging the battery of the terminal;
moving the charging coil of the battery charging system to the position of the terminal; and
charging the battery of the terminal by the charging coil of the terminal via the moved charging coil of the battery charging system.

12. The charging method of claim 11, wherein the charging coil of the battery charging system comprises a plurality of charging coils capable of separate power supply.

13. The charging method of claim 12, wherein the charging method does not supply power to the charging coils in a standby state and supplies power only to a charging coil present at the position of the terminal.

14. The charging method of claim 12, wherein the charging coil comprises a sensing unit at each of the plurality of sensing coils or includes a sensing unit at each of the plurality of sensing coils corresponding to a predetermined region.

15. The charging method of claim 11, wherein the charging coil comprises a plurality of charging coils movable to respective terminals of a plurality of terminals located in the battery charging system.

16. The charging method of claim 15, wherein one charging coil is included in each of plurality of charging sheets, to simultaneously charge the plurality of terminals.

17. The charging method of claim 11, wherein moving the charging coil of the battery charging system to the position of the terminal comprises:
moving the charging coil via a driving motor in one of up, down, left and right directions.

18. The charging method of claim 11, wherein obtaining the sensing information is obtained from one of an illumination sensor, a proximity sensor and a pressure sensor.

19. The charging method of claim 11, wherein moving the charging coil of the battery charging system to the position of the terminal comprises:
rapidly moving the charging coil near to the terminal at large intervals, if the distance between the terminal and the charging coil is large; and
accurately moving the charging coil, of the battery charging system to the position of the terminal at small intervals.

20. The charging method of claim 11, wherein the charging method is applied to portable terminals including mobile terminals.
